(19) United States
(12) Patent Application Publication
(10) Pub. No.: US 2026/0343441 A1
(43) Pub. Date: Oct. 29, 2026

(54) ENFORCING THE AF REQUESTED COVERAGE AREA WITHIN UE'S REGISTRATION AREA FOR TIME SENSITIVE COMMUNICATION AND TIME SYNCHRONIZATION SERVICES

(71) Applicant: TELEFONAKTIEBOLAGET LM ERICSSON (PUBL), Stockholm (SE)

(72) Inventors: Aleksejs Udalcovs, Stockholm (SE); Marilet De Andrade Jardim, Stockholm (SE); Shabnam Sultana, Saint-Laurent (CA); Yong Yang, Göteborg (SE); Qiuxiang Zhu, Göteborg (SE)

(21) Appl. No.: 19/124,387

(22) PCT Filed: Nov. 6, 2023
(86) PCT No.: PCT/IB2023/061188

§ 371 Date: Apr. 25, 2025

Related U.S. Application Data
(60) Provisional application No. 63/422,579, filed on Nov. 4, 2022.
(60) Provisional application No. 63/541,442, filed on Sep. 29, 2023.

(51) Int. Cl. H04W 56/00; H04W 4/021; H04W 4/12

(52) U.S. Cl. CPC H04W 56/001; H04W 4/021; H04W 4/12

(57) ABSTRACT

Methods and apparatus for activating times synchronization services or other related time sensitive communication services based on a requested coverage area are provided. A method is executed by a time sensitive communication function interworking with an Application Function for receiving a service request for providing a service in a specific coverage area for one or more User Equipments, the service request comprising a coverage area identified by one or more first tracking areas, sending to an Access and mobility management function in for example a 5G System a subscription request to receive presence in area reporting for a UE of the one or more UEs wherein the subscription request includes an area of interest (AoI) indicated by one or more tracking areas based on the one or more first tracking areas and in response to sending the subscription request, receiving a notification from the AMF indicating presence of the UE in an updated AoI aligned with a registration area (RA) of the UE different from the AoI included in the Subscription request, wherein the RA consists of a second TA list comprising at least one TA of the AoI. A method is provided for the AMF to align the AoI with the registration area of the UE and presence is reported for the UE as in the area if at least of tracking area of the AoI is included in the RA. The service is thus provided for the UE as long as the UE is that RA.

### RELATED APPLICATIONS

This application claims the benefit of provisional patent application Ser. No. 63/422,579, filed on 2022 Nov. 4 and application Ser. No. 63/541,442 filed on 2023 Sep. 29, the disclosures of which are hereby incorporated herein by reference in their entirety.

### TECHNICAL FIELD

The present disclosure relates to a wireless communication system and, more specifically, a wireless communication system communicating with a Time Sensitive communication network.

### BACKGROUND

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features, and advantages of the enclosed embodiments will be apparent from the following description.

In 3GPP SA WG #2 “Study on timing resiliency and TSC and URLLC enhancements (TR 23.700-25)” incorporated by reference in this application, one of the aspect that is addressed is to study how to enable Application Functions (AFs) to request time synchronization service in a specific coverage area and how to enforce the coverage area. This is identified as Key issue #2, KI #2, of the study which states the following: For this Key Issue the following areas should be studied how to enable AFs to request time synchronization service in a specific coverage area and whether and how to enforce the coverage area.

The study concluded with respect to KI #2, that “In order to track the UE moving in and out of Time Synchronization coverage area at a TA granularity, the Registration Area (RA) shall only include TAs either inside or outside of the requested coverage area the AF requested for Time Synchronization.” However, the AF is not aware of the RA or which tracking areas constitute a particular RA for a UE. Therefore, there might be situations where a list of TA(s) that constitute the AF requested coverage area and a list of TA(s) that constitute a RA for a certain UE targeted by this AF request are different, i.e., one of the lists have fewer or more TA(s). Therefore, there is a need for a solution that aligns these two areas or lists of Tracking areas and ensures that TA(s) in both lists are identical.

### Registration Area:

When a UE registers with the network over the 3GPP access, the AMF allocates a set of tracking areas in TAI List to the UE. When the AMF allocates to the UE registration area, (i.e., the set of tracking areas in TAI List) within which the UE can move without triggering mobility signaling to the network, it may take into account various information such as for e.g. Mobility Pattern and Allowed/Non-Allowed Area. An AMF which has the whole PLMN as serving area may alternatively allocate the whole PLMN (“all PLMN”) as registration area to a UE.

The AMF generates the TAI list identifying the RA for the UE, and when generating the TAI list, the AMF shall include only TAIs that are applicable for the access type (i.e. 3GPP access or Non-3GPP access) where the TAI list is sent to the UE.

### SUMMARY

Systems and methods are disclosed herein that provide apparatus and methods performed by a node or server implementing a network function which may be a Time Sensitive Communication Time Synchronization service function (TSCTSF) in 5GS, the method comprising the step of receiving from for example an Application Function (AF) or a Network Exposure function (NEF) a service request for providing a service in a specific coverage area for one or more User Equipments (UEs), the service request comprising a coverage area identified by one or more first tracking areas (TAs). The service request may be a request for time synchronization activation or a request to influence the 5G access stratum time distribution. The method further comprises sending to an Access and mobility management function (AMF) a subscription request to receive presence in area reporting for a UE of the one or more UEs wherein the subscription request includes an area of interest (AoI) indicated by one or more tracking areas (TAs) based on the one or more first tracking areas (TAs) and in response to sending the subscription request, the network function receiving a notification from the AMF indicating presence of the UE in an updated AoI aligned with a registration area (RA) of the UE different from the area of interest (AoI) included in the Subscription request, wherein the RA consists of a second TA list comprising at least one TA of the area of interest (AoI). The network function (e.g., TSCTSF of 5GS) may discover the AMF serving the UE, using for example NRF or UDM.

The method further comprises activating time synchronization service for the UE in the area reported by the AMF, i.e., the updated AoI.

In one aspect, the subscription request to receive presence area reporting further comprises an indication to the AMF to provide an identification of a policy control function (PCF) used for Access and Mobility (AM) policy association for the UE. In another aspect, the notification comprises an identification of the policy control function (PCF) used for Access and Mobility (AM) policy association for the UE and may include binding indication of the PCF's Access Mobility policy association resources.

In one aspect, the notification further comprises the updated AoI resulting from the alignment of the AoI from the subscription request with the RA of the UE which may be indicated by an updated TA list which comprises the second TA list that includes at least one TA of the TA list of the AoI included in the subscription request.

In one aspect, the network function further notifies the AF or the Network Exposure Function (NEF) of the service request that the coverage area has been aligned with the RA of the UE.

In accordance with another embodiment, a method performed by an access and mobility management function for performing presence area reporting for a network function that provides Time Sensitive Communication and Time Synchronization functionality (e.g., TSCTSF of 5GS) for the purpose of time synchronization service activation or influencing the 5G access stratum time distribution, the method comprising the step of receiving from the TSCTSF a subscription request for presence in area reporting for a UE wherein the subscription request includes an area of interest (AoI) indicated by one or more tracking areas (TAs), then aligning the AoI with a Registration Area (RA) assigned to the UE, the RA consisting of a second TA list, wherein when the second TA list of the RA includes at least one TA of the AoI, the AMF sending a notification to the TSCTSF to indicate the UE is inside the aligned AoI to the RA. In one aspect, aligning the AoI with a Registration Area (RA) comprises when the RA completely or partly overlaps with the AoI, the AMF updating the AoI to comprise the RA with the overlapped area.

In one aspect, when the second TA list of the RA excludes all the TAs of the AoI, the method comprises the step of sending another notification to the TSCTSF to indicate the UE is outside the aligned AoI to the RA. In another aspect, the subscription request comprises an indication to provide an identification of a policy control function (PCF) used for Access and Mobility (AM) policy association for the UE.

In another aspect, the notification comprises an identification of the policy control function (PCF) used for Access and Mobility (AM) policy association for the UE and may include a binding indication of the PCF's Access Mobility policy association resources.

In another aspect, the notification further comprises the updated AoI resulting from the alignment of the AoI from the subscription request with the RA of the UE.

In one aspect, a network server or network node is provided which is adapted to perform the methods of any one the embodiments described herein.

In another aspect, a network server or network node comprising one or more processors and memory comprising instructions which when executed by the one or more processors perform the methods the methods of any one the embodiments described herein.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates one example of a cellular communications system according to some embodiments of the present disclosure;

FIGS. 2 and 3 illustrate example embodiments in which the cellular communication system of FIG. 1 is a Fifth Generation (5G) System (5GS) supporting interworking with a Time Sensitive Network.

FIG. 4 illustrates a procedure of Time synchronization activation in requested coverage area in accordance with one example embodiment of the present disclosure;

FIG. 5 illustrates another example procedure of Time synchronization activation in requested coverage area based on FIG. 4;

FIG. 6 illustrates another example procedure of Time synchronization activation in requested coverage area in accordance with another example embodiment of the present disclosure;

FIG. 7 illustrates another example procedure of Time synchronization activation in requested coverage area based on FIG. 6;

FIG. 8 illustrates an example procedure of Time synchronization modification in accordance with some embodiments;

FIG. 9 illustrates an example procedure for management of 5G access stratum time distribution in accordance with an example embodiment of the present disclosure;

FIG. 10 illustrates a flowchart of a method implemented in a TSCTSF in accordance with the embodiments of this disclosure;

FIG. 11 illustrates a flowchart of the method implemented in an AMF in accordance with the embodiments of this disclosure.

FIG. 11b illustrates a flowchart of a method implemented in the TSCTSF in accordance with the other embodiments of this disclosure.

FIG. 12 is a schematic block diagram of a network node according to some embodiments of the present disclosure;

FIG. 13 is a schematic block diagram of the network node of FIG. 12 according to some other embodiments of the present disclosure.

FIG. 14 is a schematic block diagram that illustrates a virtualized embodiment of the network node of FIG. 12 according to some embodiments of the present disclosure.

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Radio Node: As used herein, a “radio node” is either a radio access node or a wireless communication device.

Radio Access Node: As used herein, a “radio access node” or “radio network node” or “radio access network node” is any node in a Radio Access Network (RAN) of a cellular communications network that operates to wirelessly transmit and/or receive signals. Some examples of a radio access node include, but are not limited to, a base station (e.g., a New Radio (NR) base station (gNB) in a Third Generation Partnership Project (3GPP) Fifth Generation (5G) NR network or an enhanced or evolved Node B (eNB) in a 3GPP Long Term Evolution (LTE) network), a high-power or macro base station, a low-power base station (e.g., a micro base station, a pico base station, a home eNB, or the like), a relay node, a network node that implements part of the functionality of a base station or a network node that implements a gNB Distributed Unit (gNB-DU)) or a network node that implements part of the functionality of some other type of radio access node.

Core Network Node: As used herein, a “core network node” is any type of node in a core network or any node that implements a core network function (e.g., a server or distributed servers). Some examples of a core network node include, e.g., a Mobility Management Entity (MME), a Packet Data Network Gateway (P-GW), a Service Capability Exposure Function (SCEF), a Home Subscriber Server (HSS), or the like. Some other examples of a core network node include a node implementing an Access and Mobility Function (AMF), a User Plane Function (UPF) (The UPF may include a Network Side TSN Translator (NW-TT) for TSN communication), a Session Management Function (SMF), an Authentication Server Function (AUSF), a Network Slice Selection Function (NSSF), a Network Exposure Function (NEF), a Network Function (NF) Repository Function (NRF), a Policy Control Function (PCF), a Unified Data Management (UDM), a Time Sensitive Communication and Time Synchronization Function (TSCTSF), a Network Exposure Function (NEF) or the like.

Communication Device: As used herein, a “communication device” is any type of device that has access to an access network. Some examples of a communication device include, but are not limited to: mobile phone, smart phone, sensor device, meter, vehicle, household appliance, medical appliance, media player, camera, or any type of consumer electronic, for instance, but not limited to, a television, radio, lighting arrangement, tablet computer, laptop, or Personal Computer (PC). The communication device may be a portable, hand-held, computer-comprised, or vehicle-mounted mobile device, enabled to communicate voice and/or data via a wireless or wireline connection. The communication device can include or communicate with a Device side TSN translator (DS-TT) for Time Sensitive Communication (TSN) communication.

Wireless Communication Device: One type of communication device is a wireless communication device, which may be any type of wireless device that has access to (i.e., is served by) a wireless network (e.g., a cellular network). Some examples of a wireless communication device include, but are not limited to: a User Equipment device (UE) in a 3GPP network, a Machine Type Communication (MTC) device, and an Internet of Things (IoT) device. Such wireless communication devices may be, or may be integrated into, a mobile phone, smart phone, sensor device, meter, vehicle, household appliance, medical appliance, media player, camera, or any type of consumer electronic, for instance, but not limited to, a television, radio, lighting arrangement, tablet computer, laptop, or PC. The wireless communication device may be a portable, hand-held, computer-comprised, or vehicle-mounted mobile device, enabled to communicate voice and/or data via a wireless connection. The wireless communication device can include or communicate with a DS-TT for TSN communication.

Network Node: As used herein, a “network node” is any node that is either part of the RAN or the core network of a cellular communications network/system.

Note that the description given herein focuses on a 3GPP cellular communications system and, as such, 3GPP terminology or terminology similar to 3GPP terminology is oftentimes used. However, the concepts disclosed herein are not limited to a 3GPP system.

TSCTSF: TSCTSF is a NF implemented on a node (server). The Time Sensitive Communication and Time Synchronization Function (TSCTSF) supports the following functionality:
Associating the time synchronization service request from the NF consumer to the AF sessions with the PCF (the session between the PCF and TSCTSF).
Managing the DS-TT and NW-TT via exchange of PMIC and UMIC as described in Annex K of TS 23.501 (incorporated by reference). TSCTSF controls the DS-TT(s) and NW-TT for the (g)PTP based time synchronization service.
Detecting availability of 5GS Bridge information (including user plane node ID that applies also for IP type PDU Sessions) as reported by PCF for both Ethernet and IP type PDU Sessions (including the need to (un)subscribe 5GS Bridge information Notification from PCF).
Creating the TSC Assistance Container based on individual traffic pattern parameters from the NEF/AF and providing it to the PCF.
Determining the Requested Packet Delay Budget (PDB) by subtracting the UE-DS-TT Residence Time from the Requested 5GS Delay provided by the NEF/AF and providing the determined Requested PDB to the PCF.

Note that, in the description herein, reference may be made to the term “cell”; however, particularly with respect to 5G NR concepts, beams may be used instead of cells and, as such, it is important to note that the concepts described herein are equally applicable to both cells and beams.

The solution and embodiments are explained using the 5G system using 5G network functions as an example of system and network functions where the proposed embodiments can be implemented. However, it will be apparent to a skilled reader that the solution and embodiments presented herein can be expanded to any system that implements a similar architecture as the 5G system and that interworks with a TSN, such as for example, 4G, 6G systems and beyond.

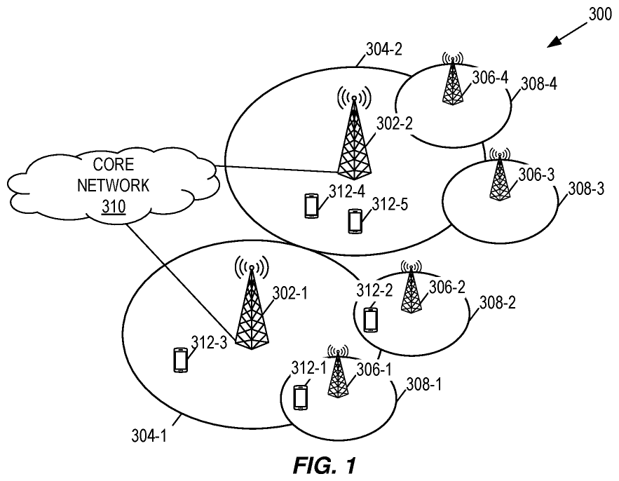

FIG. 1 illustrates one example of a cellular communications system 300 in which embodiments of the present disclosure may be implemented. In the embodiments described herein, the cellular communications system 300 may be a 5G system (5GS) including a NR RAN, an Evolved Packet System (EPS) including an LTE RAN, or a RAN that includes both 5GS and EPS components. In this example, the RAN includes base stations or NG-RAN nodes 302-1 and 302-2, which in LTE are referred to as eNBs and in 5G NR are referred to as gNBs, controlling corresponding (macro) cells 304-1 and 304-2. The base stations 302-1 and 302-2 are generally referred to herein collectively as base stations 302 and individually as base station 302. Likewise, the (macro) cells 304-1 and 304-2 are generally referred to herein collectively as (macro) cells 304 and individually as (macro) cell 304. The RAN may also include a number of low power nodes 306-1 through 306-4 controlling corresponding small cells 308-1 through 308-4. The low power nodes 306-1 through 306-4 can be small base stations (such as pico or femto base stations) or Remote Radio Heads (RRHs), or the like. Notably, while not illustrated, one or more of the small cells 308-1 through 308-4 may alternatively be provided by the base stations 302. The low power nodes 306-1 through 306-4 are generally referred to herein collectively as low power nodes 306 and individually as low power node 306. Likewise, the small cells 308-1 through 308-4 are generally referred to herein collectively as small cells 308 and individually as small cell 308. The cellular communications system 300 also includes a core network 310, which in the 5GS is referred to as the 5G core (5GC). The base stations 302 (and optionally the low power nodes 306) are connected to the core network 310.

The base stations 302 and the low power nodes 306 provide service to wireless devices 312-1 through 312-5 in the corresponding cells 304 and 308. The wireless devices 312-1 through 312-5 are generally referred to herein collectively as wireless devices 312 and individually as wireless device 312. The wireless devices 312 are also sometimes referred to herein as UEs.

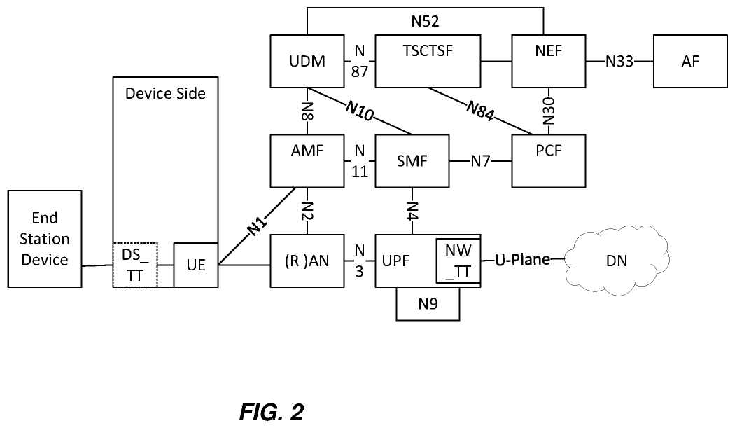

FIG. 2 illustrates a wireless communication system represented as a 5G system architecture to enable Time Sensitive Communication and Time Synchronization. The architecture in FIG. 2 is composed of core Network Functions (NFs), where interaction between any two NFs is represented by a point-to-point reference point/interface. FIG. 2 can be viewed as one particular implementation of the system 300 of FIG. 1. The architecture of FIG. 2 illustrates a 5G System that can be extended to be integrated as a bridge in an IEEE 802.1 Time Sensitive Networking (TSN). The 5GS bridge supports the Time sensitive communication as defined in IEEE 802.1 Time Sensitive Networking (TSN) standards. The 5G system in FIG. 2 enables for AF to request support of Time Synchronization and/or some aspects of Time Sensitive Communication. The NEF exposes 5GS capability to support Time Synchronization service as described in TS 23.501 release 17, V.17.6.0 incorporated by reference. The TSCTSF controls the DS-TT(s) and NW-TT for the (g)PTP based time synchronization service. In addition, TSCTSF supports TSC assistance container related functionalities. If the AF is considered to be trusted by the operator, the AF could interact directly with TSCTSF, the connection between AF and TSCTSF is not depicted in the architecture of FIG. 2 for brevity. The UPF/NW-TT distributes the (g)PTP messages as described in clause 5.27.1 of TS 23.501.

When the UPF supports one or more NW-TT(s), there is one-to-one association between an NW-TT and the network instance or between an NW-TT and network instance together with DNN/S-NSSAI in the UPF. When there are multiple network instances within a UPF, each network instance is considered logically separate.

Seen from the access side the 5G network architecture shown in FIG. 2 comprises a plurality of User Equipment (UEs) connected to either a Radio Access Network (RAN) as well as an Access and Mobility Management Function (AMF). The UE may integrate a DS-TT which communicates to an end-station (e.g., a machine). Typically, the (R)AN in FIG. 2 is also referred to as NG-RAN in this description and comprises base stations, e.g. such as evolved Node Bs (eNBs) or 5G base stations (gNBs) or similar. Seen from the core network side, the 5G core NFs shown in FIG. 2 include a Unified Data Management (UDM), an AMF, a Session Management Function (SMF), a Policy Control Function (PCF), and a User Plane Function (UPF), a NEF, a TSCTSF. However the architecture includes more NFs as described in TS 23.501.

Reference point representations of the 5G network architecture are used to develop detailed call flows in the normative standardization. The N1 reference point is defined to carry signaling between the UE and AMF. The reference points for connecting between the AN and AMF and between the AN and UPF are defined as N2 and N3, respectively. There is a reference point, N11, between the AMF and SMF, which implies that the SMF is at least partly controlled by the AMF. N4 is used by the SMF and UPF so that the UPF can be set using the control signal generated by the SMF, and the UPF can report its state to the SMF. N9 is the reference point for the connection between different UPFs, and N33 is the reference point connecting the NEF to the AF (northbound APIs). N8 and N10 are defined because the subscription data of the UE is required for the AMF and SMF. N84 and N85 are reference point between TSCTSF and PCF and between TSCTSF and NEF.

The 5G core network aims at separating user plane and control plane. The user plane carries user traffic while the control plane carries signaling in the network. In FIG. 2, the UPF is in the user plane and all other NFs, i.e., the AMF, SMF, PCF, AF, TSCTSF, NEF, and UDM, are in the control plane. Separating the user and control planes guarantees each plane resource to be scaled independently. It also allows UPFs to be deployed separately from control plane functions in a distributed fashion. In this architecture, UPFs may be deployed very close to UEs to shorten the Round Trip Time (RTT) between UEs and data network for some applications requiring low latency.

The core 5G network architecture is composed of modularized functions. For example, the AMF and SMF are independent functions in the control plane. Separated AMF and SMF allow independent evolution and scaling. Other control plane functions like the PCF and AUSF can be separated as shown in FIG. 2. Modularized function design enables the 5G core network to support various services flexibly.

Each NF interacts with another NF directly. It is possible to use intermediate functions to route messages from one NF to another NF. In the control plane, a set of interactions between two NFs is defined as service so that its reuse is possible. This service enables support for modularity. The user plane supports interactions such as forwarding operations between different UPFs.

FIG. 3 illustrates a 5G network architecture using service-based interfaces between the NFs in the control plane, instead of the point-to-point reference points/interfaces used in the 5G network architecture of FIG. 2. However, the NFs described above with reference to FIG. 2 correspond to the NFs shown in FIG. 3. The service(s) etc. that a NF provides to other authorized NFs can be exposed to the authorized NFs through the service-based interface. In FIG. 3 the service based interfaces are indicated by the letter “N” followed by the name of the NF, e.g., Namf for the service based interface of the AMF and Nsmf for the service based interface of the SMF etc. The Network Exposure Function (NEF 140) and the Network Function (NF) Repository Function (NRF 150) in FIG. 3 are not shown in FIG. 2 discussed above. However, it should be clarified that all NFs depicted in FIG. 2 can interact with the NEF and the NRF of FIG. 2 as necessary, though not explicitly indicated in FIG. 2.

Some properties of the NFs shown in FIGS. 2 and 3 may be described in the following manner. The AMF 100 provides UE-based authentication, authorization, mobility management, etc. A UE even using multiple access technologies is basically connected to a single AMF because the AMF 100 is independent of the access technologies. The SMF is responsible for session management and allocates Internet Protocol (IP) addresses to UEs. It also selects and controls the UPF for data transfer. If a UE has multiple sessions, different SMFs may be allocated to each session to manage them individually and possibly provide different functionalities per session. The AF provides information on the packet flow to the PCF 130 responsible for policy control in order to support Quality of Service (QoS). Based on the information, the PCF 130 determines policies about mobility and session management to make the AMF and SMF operate properly. The AUSF supports authentication function for UEs or similar and thus stores data for authentication of UEs or similar while the UDM stores subscription data of the UE. The Data Network (DN), not part of the 5G core network, provides Internet access or operator services and similar. The NEF 140 of for network exposure and TSCTSF for time synchronization service configuration.

An NF may be implemented either as a network element on a dedicated hardware (node or server), as a software instance running on a dedicated hardware, or as a virtualized function instantiated on an appropriate platform, e.g., a cloud infrastructure.

The examples herewith are described using the 5G network architecture, however, it will be apparent to a person skilled in the art that the solution can be applicable to any telecommunication system interworking with a TSN. The telecommunication system may be 5G, 6G or beyond.

Systems and methods that provide a solution to the aforementioned and/or other challenges are now described. The solution supports services such as time synchronization enhancements or enhancement to management of 5G access stratum time distribution as described in 3GPP TS 23.502. Time synchronization enhancements service allows Application Functions to request a specific geographical area for a time synchronization service so that the service is activated only when the service targeted UE is inside that specific area and deactivated when the UE leaves the area, but the area provided by the Application Function needs to be aligned to the registration area (RA) of the UE in the system (e.g., 5G system) since the UE registers in a RA consisting of a number of TAs in which the UE is not required to perform a mobility registration procedure and is considered reachable in the RA.

For example, an AF may activate the time synchronization service using the Nnef_TimeSynchronization_ConfigCreate service operation. The service operation creates a time synchronization configuration based on the service parameters as indicated in the ConfigCreate request. The AF may also update the time synchronization configuration using the Nnef_TimeSynchronization_ConfigUpdate service operation.

The Nnef_TimeSynchronization_ConfigCreate and Nnef_TimeSynchronization_ConfigUpdate request contains requested coverage area parameter amongst other example parameters as shown in the following table:

| Time Synchronization Parameter | Description |
|---|---|
| PTP instance type | Identifies the requested PTP instance type as described |
| | in clause 5.27.1.4 of TS 23.501 V17.6.0. |
| Transport protocol | Identifies the requested transport protocol for PTP |
| | instance as described in clause 5.27.1.4 of TS 23.501. |
| PTP Profile | Identifies the PTP profile for the PTP instance as |
| | requested by AF. |
| Grandmaster enabled | Indicates whether the AF requests the PTP instance in |
| | 5GS to be able to act as a grandmaster for PTP or |
| | gPTP (depending on the requested PTP instance type). |
| Grandmaster priority | Indicates a priority used as defaultDS.priority1 when |
| | generating Announce message when 5GS acts as |
| | (g)PTP GM. Applicable only if the Grandmaster enabled = |
| | TRUE. If omitted, the default value as described in |
| | the PTP Profile is used. |
| | [optional] |
| Time Domain | (g)PTP domain of the PTP instance. |
| Temporal Validity Condition | Indicates start-time and stop-time attributes that |
| | describe the time period when the time synchronization |
| | service for a PTP instance is active. |
| | [optional] |
| Time synchronization error budget | Indicates the time synchronization budget for the time |
| | synchronization service (as described in |
| | clause 5.27.1.9 of TS 23.501. |
| requested coverage area | Indicates a geographical area for a time |
| | synchronization service (NOTE 1). It is specified |
| | using a list of Tracking Area Identities (TAI) if the |
| | AF making the request is withing the operator's |
| | domain or using a geographical description (e.g., a |
| | civic address, shapes, etc.) if the AF making the |
| | request is outside the operator's domain [optional] |

For each PTP port in the PTP instance

| | |
|---|---|
| Either UE identity (for a DS-TT port), or “N6 | Identifies the UE/DS-TT which the parameters below |
| interface” indication | apply. “N6 interface” indicates that the parameters |
| | below apply to the N6 interface. |
| | If the “PTP port” needs to be identified, this field refers |
| | to the UE identity (GPSI or SUPI). |
| | If the N6 termination needs to be identified, then this |
| | field indicates “N6 interface” flag, instead of SUPI or |
| | GPSI. |
| PTP enabled | TRUE/FALSE. This is used to set the |
| | portDS.portEnable. If omitted, the default value as |
| | described in the PTP Profile is used. |
| | [optional] |
| Log Sync Interval | Specifies the mean time interval between successive |
| | Sync messages. If omitted, the default value as |
| | described in the PTP Profile is used. |
| [. . .] | |

(NOTE 1):
The granularity of a requested coverage area is restricted to a tracking area (TA) level

The AF may use Nnef_TimeSynchronization_CapsSubscribe service operation to learn the UE capabilities for time synchronization service. The Nnef_TimeSynchronization_CapsNotify service operation indicates the list of UE identities, User-plane Node ID and the Subscription Correlation ID. The AF can use the Subscription Correlation ID and the user-plane node ID received in the Nnef_TimeSynchronization_CapsNotify service operation as a target of the Nnef_TimeSynchronization_ConfigCreate request. The NEF uses the Subscription Correlation ID and user-plane node ID to determine the list of UEs and list of AF-sessions to which the Nnef_TimeSynchronization_ConfigCreate service operation is targeted to.

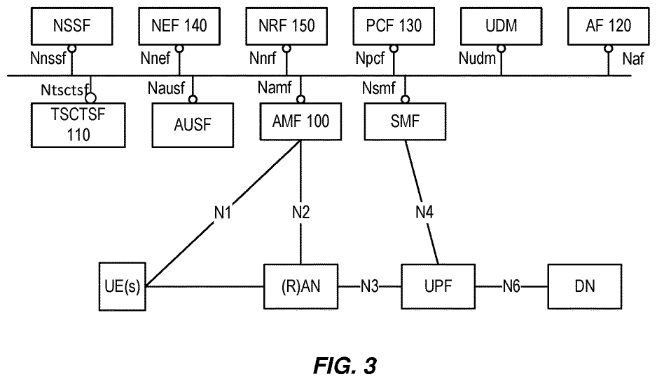

FIG. 4 illustrates a procedure for Time Synchronization activation in accordance with one example embodiment of the present disclosure. As illustrated, the procedure includes the following steps. Note, however, that depending on the particular embodiment, not all of the following steps may be performed.
Step 1. The AF 120 creates a time synchronization service configuration for a PTP instance by invoking Nnef_TimeSynchronization_ConfigCreate service operation. The request includes the parameters as described in the Table above. The request contains a Subscription Correlation ID and user-plane node ID as a reference to the target of the UEs and AF-sessions. The create request creates also a subscription for the changes in the time synchronization service configuration.
Step 2. (this step is optional if the AF 120 is not trusted) The NEF 140 authorizes the request. After successful authorization, if the AF 120 includes a requested coverage area among the request parameters, the AF describes a requested coverage area as geographical location (e.g., civic address, shape, etc.) the NEF 140 transforms the geographical information into a list of TA(s) and then invokes the Ntsctsf_TimeSynchronization_ConfigCreate service operation with the corresponding TSCTSF 110, with the parameters as received from the AF.
Note that it is assumed that AFs outside the operator's domain have an agreement with 5G network in place so that, when such AFs request a specific geographical area (using a civic address, shapes, etc.) for a time synchronization service, the requested area coincides with the RA of the UE(s) targeted by the AF request.
Alternatively, if the AF 120 is trusted, that is a part of the operator's trust domain, it may invoke the services directly with the TSCTSF 110; in this case, the AF 120 describes a requested coverage area using a list of Tracking Area Identities (TAI).
When the TSCTSF 110 receives the requested coverage area via the NEF 140 or directly from the AF, it would receive a list of TAs. The TSCTSF 110 may determine an updated coverage area TAlist based on the requested coverage area. The TSCTSF 110 shall perform a TA alignment procedure where upon obtaining the RA for a UE, the following is performed:
a) If the requested/updated coverage area contains the TA(s) outside the RA, the TSCSTSF determines that the coverage area shall be contained within the RA and the synchronization service will be activated only in the TAs comprised in the RA (excluding the TAs outside the RA).
b) If the requested/updated coverage area contains TA(s) all within the RA but the RA includes also other TA(s), the TSCSTSF determines that the coverage area over which time synchronization is to be applied shall be expanded to the full RA (i.e., new TA(s) shall be added to the list of TA specifying the requested/updated coverage area). The synchronization service will be activated in all the TAs of the RA (beyond the requested coverage area)
Step 3. The TSCTSF 110 uses the Nnrf_NFDiscovery_Request service operation and the TAI list to discover AMF(s) (100-1, 100-2) serving the TA(s).
Step 4. The NRF provides an Nnrf_NFDiscovery_Request response with a list of AMF(s) serving the TA(s) from the list TAI and comprising the spatial validity condition.
Step 5. The TSCTSF 110 invokes the Namf_EventExposure_Subscribe service operation towards the discovered AMF(s) (100-1, 100-2) to subscribe and received notifications about the UE's presence in Area of Interest (AoI), when an AoI may be the same as the requested coverage area specified by the spatial validity condition or may be a subset of the requested coverage area (e.g., a subset of TA(s) in the TAI list).
Step 6. The AMF(s) (100-1, 100-2) accepts the TSCTSF's subscription, determines a UE's presence in the AoI, and notify the TSCTSF 110 about the UE(s) presence (IN, OUT, or UNKNOWN) in the AoI.
Step 7. The TSCTSF 110 determines (based on notifications from the discovered AMF(s) (100-1, 100-2) whether the targeted UE(s) are inside or outside the requested coverage area.
   If the UE is present in one of the AoI and thereby the UE is inside the requested coverage area, the TSCTSF 110 proceeds with step 10 for the requested service activation. Later if/when the UE moves out of the requested coverage area, the TSCTSF 110 temporarily removes the UE/DS-TT from the PTP instance:
   If the DS-TT is configured to send Sync, Follow_Up and Announce messages for the related PTP instance, then TSCTSF 110 deactivates the Grandmaster functionality in the DS-TT using PMIC (see clause K.2.2.4 of TS 23.501) and removes the DS-TT from the PTP instance (see clause K.2.2.1 of TS 23.501).
   If the NW-TT is configured to send Sync, Follow_Up and Announce messages on behalf of the DS-TT, then the TSCTSF 110 deactivates the Grandmaster functionality on behalf of the DS-TT in the NW-TT using UMIC (see clause K.2.2.4 of TS 23.501) and removes the DS-TT from the PTP instance (see also clause K.2.2.1 of TS 23.501).
   The TSCTSF 110 informs the AF 120 for the impacted UE by indicating the PTP port state as Inactive for the related DS-TT PTP port.
   If the UE is not present in any of the AoI and thereby the UE is outside the requested coverage area, the TSCTSF 110 terminates the service activation and informs the AF 120 (directly or via the NEF) in step 8-9. Later if/when the UE moves inside the requested coverage area, the TSCTSF 110 adds back the DS-TT PTP port to the PTP instance and (re-)activates the Grandmaster functionality. The TSCTSF 110 informs the AF 120 for the impacted UE by indicating the PTP port state as Active for the related DS-TT PTP port.
   If the UE's presence is UNKNOWN in all AoI and thereby the TSCTSF 110 is not able to determine whether the UE inside or outside the requested coverage area, the TSCTSF 110 does not proceeds with the service activation and informs the AF 120 (directly or via the NEF) in step 8-9.
Step 8. The TSCTSF 110 responds with the Ntsctsf_TimeSynchronization_ConfigCreate response. The Ntsctsf_TimeSynchronization_ConfigCreate response includes a PTP instance reference and may include the indication that the UE(s) are (not) present in the requested coverage area (in cases when the AF 120 has requested the service for a specific area).
Step 9. The NEF 140 responds with the Nnef_TimeSynchronization_ConfigCreate response, including a reference to the time synchronization service configuration (PTP instance reference).
Step 10-11. The TSCTSF 110 uses the Subscription Correlation ID and user-plane node ID in Ntsctsf_TimeSynchronization_ConfigCreate to determine the target UEs and corresponding AF-sessions. The TSCTSF 110 uses the parameters (e.g. requested PTP instance type, transport protocol and PTP profile) in the Ntsctsf_TimeSynchronization_ConfigCreate request to determine suitable DS-TT(s) and corresponding AF-sessions among all AF-sessions that are associated with the Subscription Correlation ID and user-plane node ID in the request.
The TSCTSF 110 maintains association between list of suitable AF-sessions, corresponding time synchronization configuration, the PTP instance reference in 5GS, PTP instance references in each involved DS-TT and NW-TT and Subscription Correlation ID and user-plane node ID as given in step 1.
The AF-sessions that are not associated with a time synchronization configuration, are available to be selected as suitable AF-sessions in another Ntsctsf_TimeSynchronization_ConfigCreate request.
The TSCTSF 110 uses the procedures described in clause K.2.2 of TS 23.501 V.17.6.0 to configure and initialize the PTP instance in the DS-TT(s) and NW-TT. The TSCTSF 110 constructs a PMIC to each DS-TT/UE to activate the time synchronization service in DS-TT in respect to the service parameters in the request in step 2. The TSCTSF 110 constructs PMIC(s) and UMIC to NW-TT to activate the time synchronization service in NW-TT in respect to the service parameters in the request in step 2.
Upon reception of responses from each DS-TT and NW-TT, the TSCTSF 110 determines the state of the time synchronization configuration.
The TSCTSF 110 constructs a PMIC to each DS-TT/UE to subscribe for the port management information changes in the DS-TT. The TSCTSF 110 constructs PMIC(s) and UMIC to NW-TT to subscribe to the port management and user-plane management information changes in NW-TT. The TSCTSF 110 retrieves the PMIC(s) and UMIC via means of Npcf_PolicyAuthorization service operations.
The create request creates also a subscription for notifications for the changes in the time synchronization service configuration.
If the Ntsctsf_TimeSynchronization_ConfigCreate request contains a temporal validity condition with a start-time and/or the stop-time that is in the future, the TSCTSF 110 maintains the start-time and stop-time for the time synchronization service for the corresponding time synchronization configuration. If the start-time is in the past, the TSCTSF 110 treats the request as if the time synchronization service was activated immediately. When the start-time is reached, the TSCTSF 110 proceeds as described in this step above. When the stop-time is reached for active time synchronization service configuration, the TSCTSF 110 proceeds as if a Ntsctsf_TimeSynchronization_ConfigDelete was received as described in clause 4.15.9.3.4 of TS 23.502
The TSCTSF 110 uses the procedure in clause 4.15.9.4 to manage the 5G access stratum time distribution for the UEs that are part of the impacted PTP instance.
Step 12. The TSCTSF 110 notifies the NEF 140 (or the AF) with the Ntsctsf_TimeSynchronization_ConfigUpdateNotify service operation, containing the PTP instance reference, and the current state of the time synchronization service configuration, including and whether there was a change in the UE's presence in the requested coverage area (in cases when the AF 120 has requested the service for a specific area).
Step 13. The NEF 140 notifies the AF 120 with the Nnef_TimeSynchronization_ConfigUpdateNotify service operation, containing the PTP instance reference and the current state of the time synchronization service configuration.
Step 14. Upon a change in the PTP instance in the DS-TT or NW-TT, the DS-TT or NW-TT report the change via PMIC or UMIC to the TSCTSF 110 as described in clause K.2.2 of TS 23.501 [2].
Upon PDU Session release indication from a PCF, the TSCTSF 110 removes the corresponding AF-session from the list of AF-sessions associated with the time synchronization configuration. The TSCTSF 110 uses the procedure in clause 4.15.9.4 to remove the 5G access stratum time distribution parameters for the UE that is removed from the impacted PTP instance.
Upon PDU Session Establishment as defined clause 4.3.2.2.1, steps 10-13 in FIG. 4.15.9.2-1 are repeated for the new PDU Session and the TSCTSF 110 may notify the NEF 140 (or AF) for the Time Synchronization capability event, optionally with the updated time synchronization capabilities, as described in step 12 in FIG. 4.15.9.2-1. Note that upon receiving the notification, the NEF 140 (or AF) can use the Ntsctsf_TimeSynchronization_ConfigUpdate service operation to add the DS-TT/UE to the existing PTP instance and corresponding time synchronization service configuration.
Step 15. The TSCTSF 110 updates the state of the time synchronization configuration and may notify the NEF 140 (or AF) with the Ntsctsf_TimeSynchronization_ConfigUpdateNotify service operation, containing the PTP instance reference and the updated state of the time synchronization service configuration, including whether there was a change in the UE's presence in the requested coverage area (in cases when the AF 120 has requested the service for a specific area).
Step 16. The NEF 140 notifies the AF 120 with the Nnef_TimeSynchronization_ConfigUpdateNotify service operation, containing the reference to the time synchronization service configuration (PTP instance reference) and the updated state of the time synchronization service configuration.

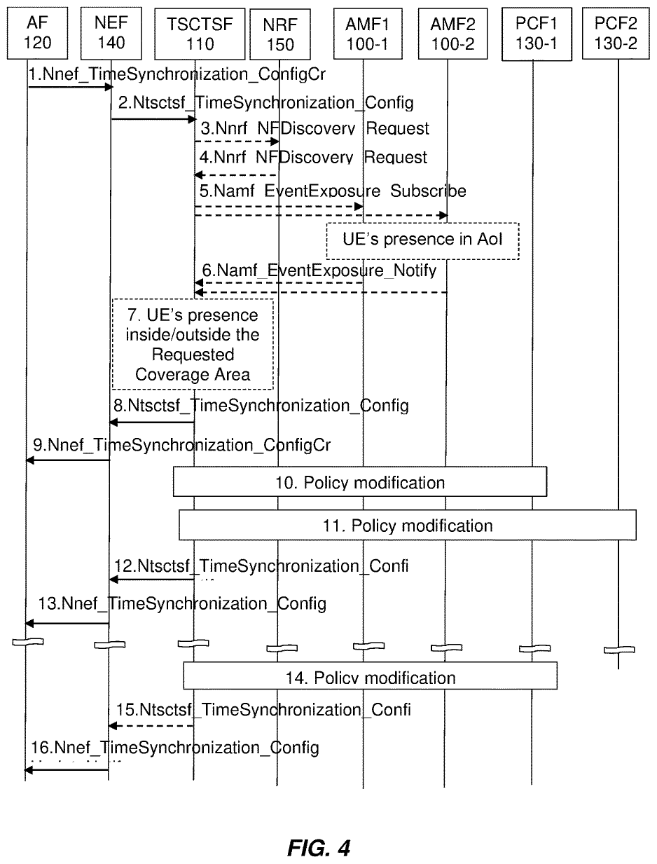

FIG. 5 illustrates a procedure describing an example of how the RA in FIG. 4 can be obtained from the AMF 100. As the AMF 100 determines the RA for a UE at the time of UE registration, the AMF 100 can notify the TSCTSF 110 of the RA when the UE registers to an AMF 100 or when the UE moves to another RA of a second AMF 100-2, in which case the second AMF-2 notifies the TSCTSF 110. FIG. 5 (based on FIG. 4) shows an example of how that notification is provided. In FIG. 5, The TSCTSF 110 performs the TA alignment after step 5, i.e., after it has obtained the RA from the AMF 100.

In FIG. 5, the TSCTSF 110 receives the requested coverage area (from NEF 140 or AF) containing a list of TAs, then proceed with discovering the AMFs (100-1, 100-2) covering the TAs. The TSCTSF 110 then at step 3 sends a Subscription request to the AMF(s) (100-1, 100-2) to subscribe to RA notification based on the UE identity(ies) and the TA(s). An AMF 100 identifies an RA based on the TA(s) and UE identity (ies) and reports the RA for a UE back to the TSCTSF 110 if the UE is registered and has a registration context in the AMF 100.

Once the TSCTSF 110 receives the RA from the AMF 100, it will perform the TA alignment as described in step 1 of FIG. 4 (Above). In step 7 of FIG. 5, the TSCTSF 110 may notify the AF 120 (perhaps via the NEF) that the requested coverage has changed if the TA alignment resulted in a change of requested coverage area. Step 8 of FIG. 5 is similar to Step 5 of FIG. 4.

Another example is for verticals deploying private networks where wide area coverage is not required and UEs are deployed in for example a factory floor with limited coverage, the registration area (RA) may be static and the same RA may be assigned to all the UEs registered in that area, hence the TSCTSF 110 may obtain the RA via configuration, a management system or via the AMF 100 at the time of UE registration (i.e., reporting is triggered by the UE capability (subscription or otherwise) of supporting time synchronization.

In one example, the RA reporting by the AMF 100 may occur before step 1, if the AMF 100 is configured statically or dynamically that based on UE capability obtained from the UE or from the subscription, that TSCTSF 110 needs to be notified of the UE RA. The TSCTSF 110 may have the RA available at the time of receiving the coverage area request.

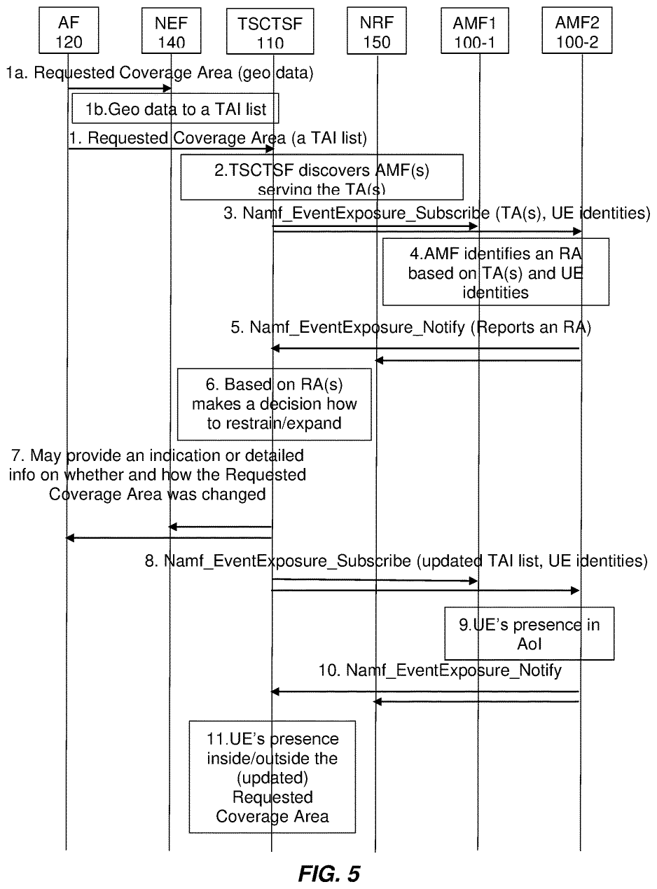

FIG. 6 describes another example where it is the AMF 100 that performs the TA alignment instead of the TSCTSF 110. The AMF 100 in FIG. 6 makes the decision whether to restrain/expand a TAI list of a coverage area for time synchronization service according to the RA allocated to the UE. It is assumed that the requested coverage area is served by a single AMF 100. Steps 1 and 2 are similar to FIG. 5. At step 3, the TSCTSF 110 includes the TA list and UE (s) based on the TAs included in the coverage area request in the subscription request to presence area reporting to the AMF 100. The AMF 100 being discovered based on the TAs of the TA list. The AMF 100 in step 4 of FIG. 6 identifies the RA for the UE(s) and then perform the TA alignment procedure similar to the procedure described in step 2 of FIG. 4, i.e., it makes a decision to restrain or expand the TA list of the coverage area as the following:
a) If the received area (coverage area or area for presence area reporting) in the subscription from TSCTSF 110 contains some TA(s) outside the RA and some TAs within the RA, the AMF 100 determines that the coverage area (i.e., the area for presence area reporting) shall be contained within the RA, i.e., the area for presence area reporting includes TAs in the RA which comprises some overlapped TAs from the TSCTSF 110 and the synchronization service will be activated only in the TAs comprised in the RA or in the RA (excluding the TAs from the coverage area that are outside the RA). The AMF 100 would report the UE is IN the area (restrained received area aligned with the RA).
b) If the received area (coverage area or area for presence area reporting) contains TA(s) that are all within the RA but the RA may includes also other TA(s), the AMF 100 determines that the coverage area (i.e., the area for presence area reporting) shall be expanded/aligned to the full RA (i.e., new TA(s) may be added to the list of TA specifying the received area if the RA is larger than the received area). The synchronization service will be activated in all the TAs of the RA (beyond the requested coverage area). The AMF 100 report the UE is IN the area (expanded received area aligned with RA).
   The AMF 100 will then only report to the TSCTSF 110 the presence of the UE(s) within the coverage area which is the aligned received area. If a) or b) the UE is reported as IN, if no alignment to RA can be done because there are no TAs in the received area that are in the RA, the AMF 100 reports as OUT of the area. The AMF 100 may also include an indication in the presence area reporting to the TSCTSF 110 that the coverage area has been restrained or expanded (to align with the RA) i.e., that the TA list provided at step 3 in the subscription has been modified to align with the RA. In step 8 of FIG. 6, the TSCTSF 110 may notify the AF 120 (perhaps via the NEF) that the requested coverage has changed if the TA alignment in the AMF 100 resulted in a change of requested coverage area.

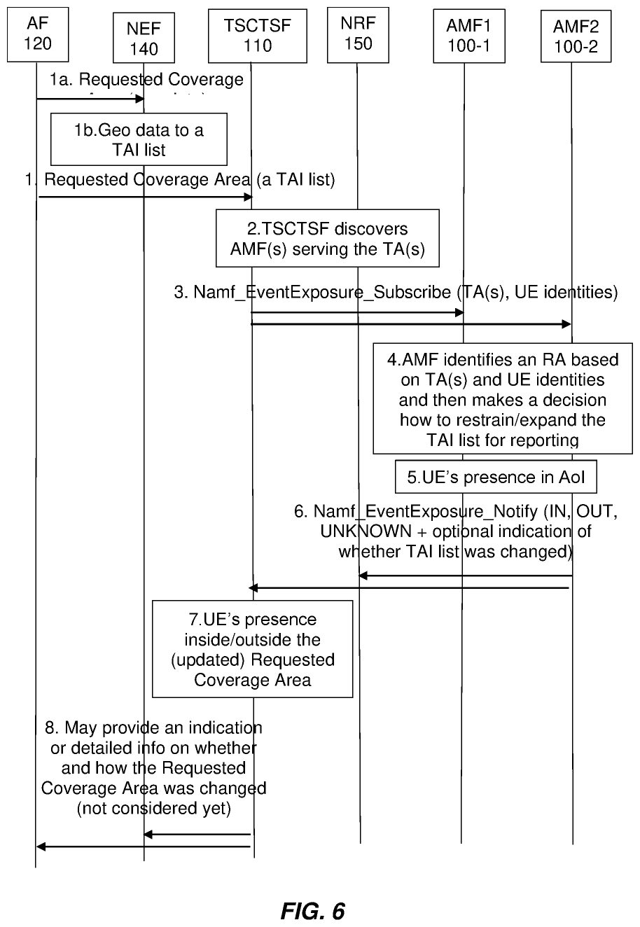

FIG. 7 describes another example based on FIG. 6 where the AMF 100 reports to the TSCTSF 110 not only UE's presence in Area of Interest (AoI) (IN, OUT, Unknow) but also provides a list of TAI that were considered as the AoI when reporting the UE is IN the area. In this case, the Area of Interest is included and contains the TA(s) provided by the TSCTSF 110 at step 3 (TA provided as part of the coverage area request) and +/− some other TA(s) based on alignment with UE's RA.

The FIGS. 4-7 above address examples of time synchronization activation. However, the time synchronization service can be modified and deactivated as well.

### Time Synchronization Service Modification

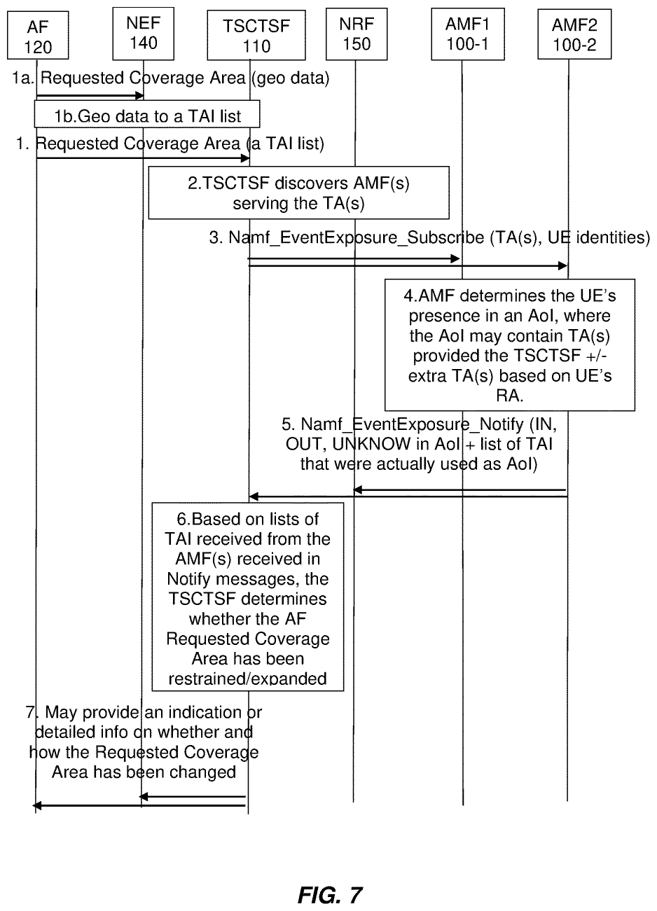

FIG. 8 illustrates a time synchronization modification procedure in accordance with other examples. In step 1 the AF 120 invokes a Nnef_TimeSynchronization_ConfigUpdate service operation providing the corresponding PTP instance reference.

In step 2: The NEF 140 (if involved) invokes the Ntsctsf_TimeSynchronization_ConfigUpdate service operation with the corresponding TSCTSF 110. Else, the AF 120 that is a part of the operator's trust domain may invoke the services directly with the TSCTSF 110.

Step 3: If the update request includes changes in the requested coverage area, the TSCTSF 110 determines the UE's presence in the updated requested coverage area using any of the examples described in FIG. 4, 5, 6 or 7 of the time synchronization activation procedure.

Step 4. The TSCTSF 110 responds with the Ntsctsf_TimeSynchronization_ConfigUpdate response to NEF 140 or AF 120 where the AF 120 may include an indication that the UE(s) are (not) present in the requested coverage area (in cases when the AF 120 has requested the service for a specific area).

Step 5. The NEF 140 responds with the Nnef_TimeSynchronization_ConfigUpdate.

Steps 6-7. The TSCTSF 110 uses the PTP instance reference included in the Ntsctsf_TimeSynchronization_ConfigUpdate request to identify the time synchronization service configuration and the corresponding AF sessions using PCF 130 in accordance with clause K.2.2 of TS 23.501. Two instances of PCF are shown (when the AF requests involves multiple UEs served by different PCF instances 130-1, 130-2).
If the Ntsctsf_TimeSynchronization_ConfigUpdate request includes updated service parameters for the PTP instance and if the corresponding DS-TT(s) and NW-TT are suitable with the parameters (e.g. requested PTP instance type, transport protocol and PTP profile), the TSCTSF 110 uses the procedures described in clause K.2.2 of TS 23.501 to update the PTP instance(s) in the DS-TT(s) and NW-TT.
If the Ntsctsf_TimeSynchronization_ConfigUpdate request includes one or more UE identities to be added to the PTP instance, if the corresponding DS-TT(s) are suitable with the parameters (e.g. requested PTP instance type, transport protocol and PTP profile) in the time synchronization service configuration as identified by the PTP instance reference in the request:
   the TSCTSF 110 adds the suitable AF-sessions to the list of AF-sessions that are associated with the time synchronization service configuration; and
   the TSCTSF 110 uses the procedures described in clause K.2.2 of TS 23.501 to initialize and activate the PTP instance(s) in the corresponding DS-TT(s).
   the TSCTSF 110 uses the procedure in clause 4.15.9.4 to manage the 5G access stratum time distribution for the UEs that are added to the impacted PTP instance.
If the Ntsctsf_TimeSynchronization_ConfigUpdate request includes one or more UE identities to be removed to the PTP instance, the TSCTSF 110 removes the corresponding AF sessions from the list of AF-sessions associated with the time synchronization configuration. The TSCTSF 110 uses the procedure in clause 4.15.9.4 to remove the 5G access stratum time distribution parameters for the UEs that are removed from the impacted PTP instance.

Step 8. The TSCTSF 110 notifies the NEF 140 (or AF) with the Ntsctsf_TimeSynchronization_ConfigUpdateNotify service operation, containing the PTP instance reference and the current state of the time synchronization service configuration, including and whether there was a change in the UE's presence in the requested coverage area (in cases when the AF 120 has requested the service for a specific area).

Step 9. The NEF 140 notifies the AF 120 with the Nnef_TimeSynchronization_ConfigUpdateNotify service operation, containing the PTP instance reference and the current state of the time synchronization service configuration.

### Time Synchronization Service Deactivation

The TSCTSF 110 may also invoke the Ntsctsf_TimeSynchronization_ConfigDelete service operation if/when it determines (based on notifications from the AMF(s) of (100-1, 100-2) presence area reporting (FIG. 4, 5, 6, 7) that the UE(s) are outside the requested coverage area.

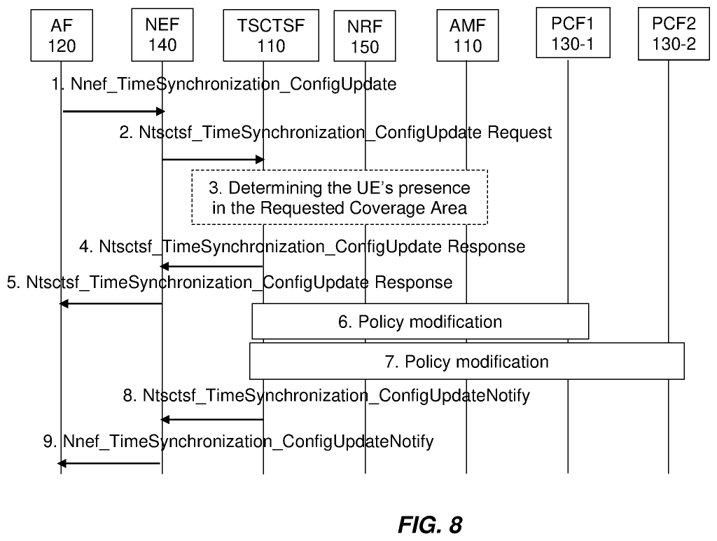

FIG. 9 is an example procedure for management of 5G access stratum time distribution according to some embodiments. The AF 120 can use the procedure to activate, update or delete the 5G access stratum time distribution for one UE or a group of UEs.

The AF 120 may query the status of the 5G access stratum time distribution using Nnef_ASTI_Get service operation. The Nnef_ASTI_Create and Nnef_ASTI_Update request may contain the parameters as described in Table below which includes the requested coverage area/spatial validity condition for the request.

### Table: Description of 5G Access Stratum Time Distribution Parameters

| Parameter | Description |
|---|---|
| 5G access stratum time distribution | Indicates that the access stratum time distribution via |
| indication (enable, disable) | Uu reference point should be activated or deactivated |
| | for the associated UE identities. |
| Time synchronization error budget | Indicates the time synchronization error budget for the |
| | time synchronization service. |
| | [optional] |
| Temporal Validity Condition | Indicates start-time and stop-time attributes that |
| | describe the time period when the time synchronization |
| | service is active. |
| | [optional] |
| Spatial Validity Condition | Indicates a geographical area (e.g. a civic address or |
| | shapes) or a TA list in which time synchronization |
| | service is enabled (NOTE 1). |
| | [optional] |
| Clock quality detail level | It indicates whether and which clock quality information |
| | to provide to the UE and can take one of the following |
| | values “clock quality metrics” or “acceptable/not |
| | acceptable indication”. |
| | [optional] |
| Clock quality acceptance criteria | It indicates acceptance criteria for the UE. It is defined |
| | based on the attributes specified in Table 5.27.1.12-1 of |
| | TS 23.501. The parameter shall be included if the |
| | “clock quality detail level” = “acceptable/not |
| | acceptable”. |
| | [conditional] |

(NOTE 1):
A geographical area requested by an AF includes at least one tracking area (TA), i.e. the granularity is restricted to a TA level in this release of the specifications.

The steps of FIG. 9 are described as follows:
1. AM Policy Association establishment as described in clause 4.16.1 of TS 23.501.
2. (When the procedure is triggered by the AF request to influence the 5G access stratum time distribution):
   To create a new request, the AF 120 provides access stratum time distribution parameters to the NEF 140 using the Nnef_ASTI_Create service operation (together with the AF identifier and potentially further inputs as specified in table just above, including a target (one UE identified by SUPI or GPSI, a group of UEs identified by an External Group Identifier). The NEF 140 forwards the GPSI or the External Group Identifier to the TSCTSF 110 by including it inside the Ntsctsf_ASTI_Create request.
   To update or remove an existing request, the AF 120 invokes an Nnef_ASTI_Update or Nnef_ASTI_Delete service operation providing the corresponding time synchronization configuration id.
   To query the status of the access stratum time distribution, the AF 120 invokes Nnef_ASTI_Get service operation providing the target (a list of UE identities (SUPI or GPSIs) or an External Group Identifier).
The AF 120 that is a part of the operator's trust domain may invoke the services directly with the TSCTSF 110; the AF 120 identifies the targeted UE(s) using SUPI(s) or an Internal Group Identifier and describes a requested coverage area/spatial validity condition using a list of Tracking Area Identities (TAI).

Coverage area to RA alignment can then be done in accordance with FIG. 4, 5, 6, or 7.
NOTE that Steps 1 and 2 can occur in any order.
3. (When the procedure is triggered by the AF request to influence the 5G access stratum time distribution):
   The NEF 140 authorizes the request. After successful authorization, if the AF 120 includes a requested coverage area inside the request parameters, the NEF 140 transforms the geographical information into a list of TA(s) and then invokes the Ntsctsf_ASTI_Create/Update/Delete/Get service operation with the TSCTSF 110 discovered and selected as described in clause 6.3.24 of TS 23.501 [2].
NOTE 3: It is assumed that AFs outside the operator's domain have an agreement with 5G network in place so that, when such AFs request a specific geographical area (using a civic address, shapes, etc.) for a time synchronization service, the requested area coincides with the RA of the UE(s) targeted by the AF request.
   The TSCTSF 110 determines whether the targeted UE is part of a PTP instance in 5GS, if so the TSCTSF 110 rejects the request (steps 4-10 are skipped).
(When the procedure is triggered by PTP instance activation, modification, or deactivation in the TSCTSF 110):
   If time synchronization error budget is provided by the AF, the TSCTSF 110 may use the PTP port state of each DS-TT to determine an Uu time synchronization error budget for corresponding SUPIs that are part of the PTP instance.
   If time synchronization error budget is provided by the AF, the TSCTSF 110 calculates the Uu time synchronization error budget as described in clause 5.27.1.9 of TS 23.501 [2].
4. (not show in the figure) If the AF targeted UE(s) are identified by GPSI(s) or an External/Internal Group Identifier, the TSCTSF 110 uses the Nudm_SDM_Get request to retrieve the subscription information (SUPI(s)) from the UDM using each GPSI or the External Group Identifier as received from the NEF, or an Internal Group Identifier as provided by the AF 120 directly.
5. (not shown in the figure) The UDM provides the Nudm_SDM_Get response containing SUPI(s) that are mapped from each received GPSI or the External/Internal Group Identifier and identify the targeted UEs.
6. If the AF 120 includes a requested coverage area inside the request, the TSCTSF 110 uses the Nnrf_NFDiscovery_Request service operation and the TAI list to discover AMF(s) (100-1, 100-2) serving the TA(s).
7. The NRF provides an Nnrf_NFDiscovery_Request response with a list of AMF(s) (100-1, 100-2) serving the TA(s) from the list TAI and comprising the spatial validity condition.
8. The TSCTSF 110 invokes the Namf_EventExposure_Subscribe service operation towards the discovered AMF(s) (100-1, 100-2) to subscribe to notifications about the UE's presence in Area of Interest (AoI), when an AoI may be the same as the requested coverage area specified by the spatial validity condition or may be a subset of the requested coverage area (e.g., a subset of TA(s) in the TAI list). Additionally, when invoking the Namf_EventExposure_Subscribe, the TSCTSF 110 may include an indication to the AMF 100 to provide the PCF ID that is handling the AM Policy for the UE, the indication may further indicate to the AMF 100 to include the relevant binding information in cases when for example the request from the AF 120 in step 2 contains a spatial validity condition, i.e., requested coverage area.
9. The AMF(s) (100-1, 100-2) accepts the TSCTSF's subscription, determines UE's presence in the AoI, and notify the TSCTSF 110 about the UE(s) presence (IN, OUT, or UNKNOWN) in the AoI after potentially performing the AoI to RA alignment. The AMF 100 may additionally include an identity of the PCF instance (PCF ID) that handles the AM Policy Association of the UE and optionally the relevant binding information. In another example, the AMF 100 may take into account the indication if received from the TSCTSF 110 in step 8 to determine whether it should provide the PCF ID to the TSCTSF 110, so the TSCTSF 110 can use it to determine the identity of the PCF instance for the AM policy Association of the UE instead of querying the BSF.
10. The TSCTSF 110 determines (based on notifications from the discovered AMF(s) (100-1, 100-2)) whether the targeted UE(s) are inside or outside the requested coverage area.
   If the UE is present in one of the AoI and thereby the UE is inside the requested coverage area, the TSCTSF 110 proceeds with the creation/update of the requested service in case when the TSCTSF 110 have received the Ntsctsf_ASTI_Create/Update request). Later if/when the UE moves out of the requested coverage area, the TSCTSF 110 temporarily deactivates the ongoing synchronization service as described in clause 4.15.9.4.
   If the UE is not present in any of the AoI and thereby the UE is outside the requested coverage area, the TSCTSF 110 does not proceed with the service creation/update and provides response to the AF 120 (via the NEF) as in step 18. Later if/when the UE moves into an AoI and thereby the UE is inside the requested coverage area, the TSCTSF 110 may proceed with the requested service activation as described in step 13.
   If the UE's presence is UNKNOWN in all AoI and thereby the TSCTSF 110 is not able to determine whether the UE inside or outside the requested coverage area, the TSCTSF 110 keeps the ongoing service unchanged (in cases when the AF 120 requests the service update via Ntsctscf_ASTI_Update) or does not proceed with a service activation (in case when the AF 120 requests a new service via Ntsctsf_ASTI_Create) until the TSCTSF 110 determines that the UE is inside/outside the requested coverage area.
11-12. The TSCTSF 110 informs the AF 120 (directly or via the NEF) about the UE's presence in the requested coverage area using the Ntsctsf_ASTI_UpdateNotify service operation if the TSCTSF 110 determines there is a change.
13. The TSCTSF 110 determines the PCF 130 for the UE:
   a) According to the current procedure, the TSCTSF 110 finds a PCF 130 serving the UE by querying the BSF 160 using Nbsf_Management_Subscribe service with a SUPI as an input parameter, indicating that it is searching for the PCF 130 that handles the AM Policy Association of the UE, or if the proposed enhancements are applied, the TSCTSF 110 can save an extra signalling step by requesting the AMF 100 to provide the identity of the PCF 130 serving the UE.
   b) if the AMF 100 has indicated the identification of the PCF 130 instance at step 9 and optionally the relevant binding information, the TSCTSF 110 does not need to use the BSF service in a), step 14 is also skipped and the TSCTSF 110 can proceed to step 15. Inclusion of the PCF instance ID serving the AM policy for the UE at step 9 is considered an optimization to the procedure.
14. The BSF provides to the TSCTSF 110 the identity of the PCF 130 for the UE for the requested SUPI via an Nbsf_Management_Notify operation. If matching entries already existed in the BSF when step 13 is performed, this shall be immediately reported to the TSCTSF 110.
15. The TSCTSF 110 sends to the PCF 130 for the UE its request for the AM policy of the UE (identified by SUPI) using Npcf_AMPolicyAuthorization request, containing the 5G access stratum time distribution indication (enable, disable) and optionally the calculated Uu time synchronization error budget.
16. If the PCF 130 receives multiple time synchronization error budgets for a given UE, then the PCF 130 picks the most stringent budget. The PCF 130 takes a policy decision and then the PCF 130 may initiate an AM Policy Association Modification procedure for the UE as described in clause 4.16.2.2 to provide AMF 100 the 5G access stratum time distribution parameters. As part of this, the AMF 100 shall, if supported, store the 5G access stratum time distribution indication (enable, disable) and the Uu time synchronization error budget in the UE context in AMF 100 and send the 5G access stratum time distribution indication (enable, disable) and the Uu time synchronization error budget, when they are available, to NG-RAN during mobility registration, AM policy modification, Service Request, N2 Handover and Xn handover as specified in TS 38.413 [10]. The NG-RAN node shall, if supported, store the information in the UE Context. Based on this information, the NG-RAN node provides the 5GS access stratum time to the UE according to the Uu time synchronization error budget as provided by the TSCTSF 110 (if supported by UE and NG-RAN).
NOTE 4: This release of the specification assumes that deployments ensure that the targeted UEs and the NG-RAN nodes serving those UEs support Rel-17 propagation delay compensation as defined in TS 38.300 [30].
17. The PCF 130 of the UE replies to the TSCTSF 110 with the result of Npcf_AMPolicyAuthorization operation.
18. The TSCTSF 110 responds the AF 120 (via the NEF) with the Ntsctsf_ASTI_Create/Update/Delete/Get service operation response.
19. The NEF 140 informs the AF 120 about the result of the Nnef_ASTI_Create/Update/Delete/Get service operation performed in step 2.

In accordance with some embodiment the Event exposure API between the TSCTSF 110 and the AMF 100 are modified to support additional information as illustrated below.

### Namf_EventExposure_Subscribe Service Operation

Service operation name: Namf_EventExposure_Subscribe.
Description: The consumer NF uses this service operation to subscribe to or modify event reporting for one UE, a group of UE(s) or any UE.
Input, Required: NF ID, Target of Event Reporting: UE(s) ID (SUPI or Internal Group Identifier or indication that any UE is targeted), ((set of) Event ID(s), Notification Target Address (+ Notification Correlation ID))s, Event Reporting Information, e.g., AoI if AoI reporting event.
Input, Optional: (Event Filter (s) associated with each Event ID; Event Filter (s) are defined in clause 5.2.2.3.1 of TS 23.502, Subscription Correlation ID (in the case of modification of the event subscription), Expiry time, list of group member UE(s) whose subscription to event notification(s) are removed or added for a group-based event notification subscription, operation indication (cancellation or addition), Idle Status Indication request (if UE reachability or Availability after DDN failure reporting is requested), indication to report the PCF ID handling AM Policy together with the relevant binding information.
Output, Required: When the subscription is accepted: Subscription Correlation ID (required for management of this subscription), Expiry time (required if the subscription can be expired based on the operator's policy).
Output, Optional: First corresponding event report is included, if available (see clause 4.15.1 of TS 23.502).

### Namf_EventExposure_Notify Service Operation:

Service operation name: Namf_EventExposure_Notify.
Service operation description: Provides the previously subscribed event information to the NF Consumer which has subscribed to that event before.
Input, Required: AMF ID (GUAMI), Notification Correlation Information, Event ID, corresponding UE(s) (SUPI(s) and if available GPSI(s)), time stamp.
Input, Optional: Event specific parameter list, Idle Status Indication (time when UE returned to Idle, Active Time, Periodic Update Timer, eDRX cycle, suggested number of DL packets), PCF ID handling AM Policy together with the relevant binding information.
Output, Required: None.
Output, Optional: None.

The detailed parameters for AMFevent are described below in accordance with some embodiments. Table 2 illustrates an example of the structure of information elements of AMFevent transmitted from TSCTSF 110 to AMF 100 as part of the event subscription defined in the 3GPP standard (proposed changes to the standard are presented in bold).

TABLE 2

| | | | | | |
|---|---|---|---|---|---|
| Attribute name | Data type | P | Cardinality | Description | Applicability |

| | | | | |
|---|---|---|---|---|
| type | AmfEventType | M | 1 | Describes the AMF event type to be |
| | | | | reported |
| immediateFlag | boolean | O | 0 . . . 1 | Indicates if an immediate event report |
| | | | | containing the currently available value/ |
| | | | | status of the event is requested. The report |
| | | | | contains the value/status of the event |
| | | | | currently available at the AMF at the time of |
| | | | | the subscription. If the flag is not present |
| | | | | then immediate reporting shall not be done |
| | | | | and the first report is sent at event detection |
| | | | | time. |
| | | | | When the subscribing NF subscribes on |
| | | | | behalf of another NF, the IERSR feature |
| | | | | controls whether or not an immediate report |
| | | | | is sent within the subscribe response |
| | | | | message or within a notification request |
| | | | | message. Otherwise immediate reports are |
| | | | | always sent within the subscribe response |
| | | | | message. |
| | | | | The default value is false. |
| areaList | array(AmfEventArea) | O | 1 . . . N | Identifies the area to be applied. |
| | | | | More than one instance of AmfEventArea IE |
| | | | | shall be used only when the AmfEventArea |
| | | | | is provided during event subscription for |
| | | | | Presence Reporting Area subscription. |
| locationFilterList | array(LocationFilter) | O | 1 . . . N | Describes the filters to be applied for |
| | | | | LOCATION_REPORT event type. |
| | | | | If this attribute is not present in the request, |
| | | | | it indicates the change of the TA used by |
| | | | | the UE should be reported. |
| [. . .] | | | | |
| adjustAoIOnRa | boolean | O | 0 . . . 1 | This IE may be present if the (event) type IE |
| | | | | is set to “PRESENCE_IN_AOI_REPORT”. |
| | | | | When present, it shall be set as follows: |
| | | | | true: the AMF may adjust the |
| | | | | received AoI based on the UE's |
| | | | | registration area. |
| | | | | false (default) the AoI shall remain |
| | | | | unchanged, i.e. it shall not be |
| | | | | adjusted based on the UE's |
| | | | | registration area. |
| [. . .] | | | | |
| pcfInfoInd | boolean | O | 0 . . . 1 | This IE may be present if the (event) type |
| | | | | IE is set to |
| | | | | “PRESENCE_{—}IN_{—}AOI_{—}REPORT”. |
| | | | | When present, it shall be set as follows: |
| | | | | true: AMF reports a PCF ID |
| | | | | handling AM Policy together with |
| | | | | the relevant binding information. |
| | | | | false (default): AMF doesn't report |
| | | | | a PCF ID handling AM Policy |
| | | | | together with the relevant binding |
| | | | | information. |

Table illustrates examples of information structure of AMFeventreport provided from the AMF 100 to TSCTSF 110 when reporting AoI (changes in bold).

| | | | | | |
|---|---|---|---|---|---|
| Attribute name | Data type | P | Cardinality | Description | Applicability |

| | | | | |
|---|---|---|---|---|
| type | AmfEventType | M | 1 | Describes the type of the event which triggers |
| | | | | the report |
| [. . .] | | | | |
| subscriptionId | Uri | C | 0 . . . 1 | This IE shall be included when the event |
| | | | | notification is for informing the creation of a |
| | | | | subscription Id at the AMF during mobility of a |
| | | | | UE across AMFs. |
| | | | | When present, this IE shall contain the URI of |
| | | | | the created subscription resource at the AMF; |
| | | | | this shall contain an absolute URI set to the |
| | | | | Resource URI. |
| | | | | The type IE shall be set to: |
| | | | | SUBSCRIPTION_ID_CHANGE, |
| | | | | when the AMFcreates a subscription Id for |
| | | | | a UE specific event subscription during |
| | | | | mobility registration and handover |
| | | | | procedures involving an AMF change. |
| | | | | SUBSCRIPTION_ID_ADDITION, |
| | | | | when the AMF creates a subscription Id |
| | | | | for a group Id specific event subscription |
| | | | | during mobility registration and handover |
| | | | | procedures involving an AMF change. |
| anyUe | boolean | C | 0 . . . 1 | This IE shall be included and shall be set to |
| | | | | “true”, if the event subscription is a bulk |
| | | | | subscription for number of UEs and the event |
| | | | | reported is for one of those UEs. |
| supi | Supi | C | 0 . . . 1 | This IE shall be present if available. |
| | | | | When present, this IE identifies the SUPI of |
| | | | | the UE associated with the report |
| areaList | array(AmfEventArea) | C | 1 . . . N | This IE shall be present when the AMF event |
| | | | | type is “PRESENCE_IN_AOI_REPORT”. |
| | | | | When present, this IE represents the specified |
| | | | | Area(s) of Interest the UE is currently IN/ |
| | | | | OUT/UNKNOWN. |
| | | | | If the AMF event is subscribed towards a PRA |
| | | | | identifier referring to a Set of Core Network |
| | | | | predefined Presence Reporting Areas, the |
| | | | | AMF shall report both the subscribed PRA |
| | | | | Identifier and the additional PRA identifier of |
| | | | | the actually individual PRA(s) where the UE is |
| | | | | currently IN/OUT |
| [. . .] | | | | |
| location | UserLocation | O | 0 . . . 1 | Represents the location information of the UE |
| | | | | This IE shall convey exactly one of the |
| | | | | following: |
| | | | | E-UTRA user location |
| | | | | NR user location |
| | | | | Non-3GPP access user location. |
| | | | | If the additionalLocation IE is present, this IE |
| | | | | shall contain either an E-UTRA user location |
| | | | | or NR user location. |
| [. . .] | | | | |
| pcfId | NfInstanceId | C | 0 . . . 1 | This IE shall be present when the AMF |
| | | | | event type is |
| | | | | “PRESENCE_{—}IN_{—}AOI_{—}REPORT” when |
| | | | | there is indication to report the PCF ID |
| | | | | handling AM Policy together with the |
| | | | | relevant binding information in the |
| | | | | subscription. |
| pcfAmpBindingInfo | string | C | 0 . . . 1 | This IE shall be present when available |
| | | | | and when the PCF ID handling AM Policy |
| | | | | is required. When present, this IE shall |
| | | | | contain the Binding indications of the |
| | | | | PCF's AM policy association resources |
| | | | | and shall be set to the value of the 3gpp- |
| | | | | Sbi-Binding header defined in |
| | | | | clause 5.2.3.2.6 of 3GPP TS 29.500, without |
| | | | | the header name. |

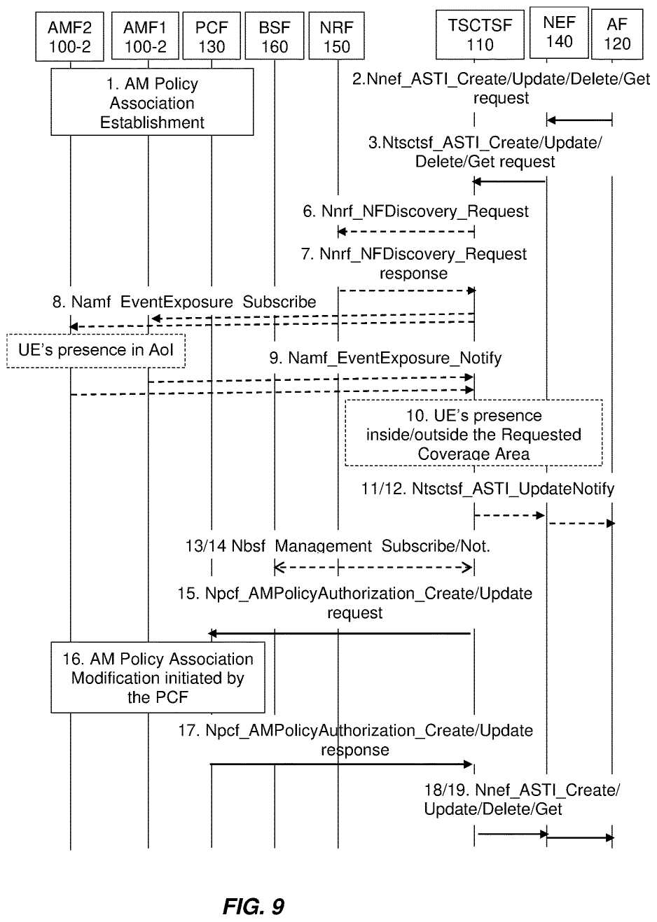

FIG. 10 is a flowchart describing the steps of TA alignments performed by TSCTSF for a time synchronization service in accordance with some embodiments in accordance with FIGS. 4 and/or 5.

At step 1005, when the TSCTSF receives a service request from a time sensitive network (e.g., a time synchronization service request) with requested coverage area via the NEF or directly from the AF, the coverage area includes a list of TAs. At step 1010, the TSCTSF obtains the RA for a UE. In one example, the TSCTSF obtains the RA from the AMF using for example the UE identity by for example querying the UDM for the AMF serving the UE or obtains the RA from a management system. In one example, the obtaining step 1010 may occur subsequent to receiving a time synchronization service with coverage area in step 1000 and subscribing to the AMFs serving the TAs of the coverage area request. In another example, the obtaining step may occur at time of UE registration before receiving the coverage area request. In this case, the TSCTSF may have previously subscribed to receive the notification based on UE capability of supporting time synchronization service. The capability may be provided by the UE to the AMF or by the subscription at the AMF, at which point the AMF reports the assigned RA to the TSCTSF.

At step 1020a If the requested coverage area contains TA(s) that are all included within the RA but the RA includes also other TA(s), the method includes the step 1030a of expanding the requested coverage area to include the other TAs of the RA (i.e., new TA(s) will be added to the list of TAI specifying the requested coverage area. The synchronization service will be activated in all the TAs of the RA (beyond the requested coverage area). At step 1020b, if the requested coverage area contains the TA(s) outside the RA but still overlaps with the RA, the method includes the step 1030b of determining that the requested coverage area shall be contained within the RA. i.e., the TSCTSF excludes the TAs from the coverage area that are outside the RA, so the synchronization service will be activated only in the coverage area TAs of the RA and not in the coverage area TAs that are outside the RA.

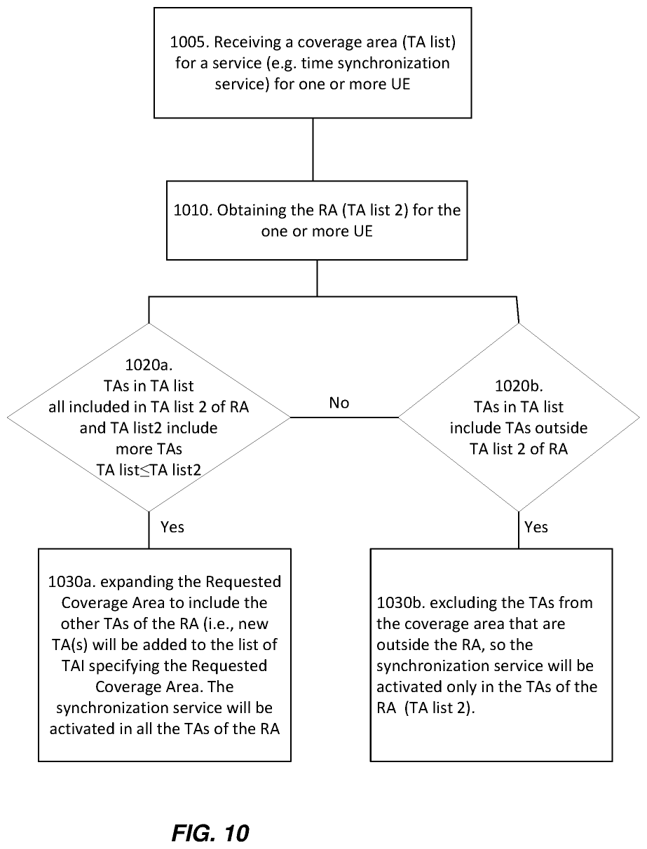

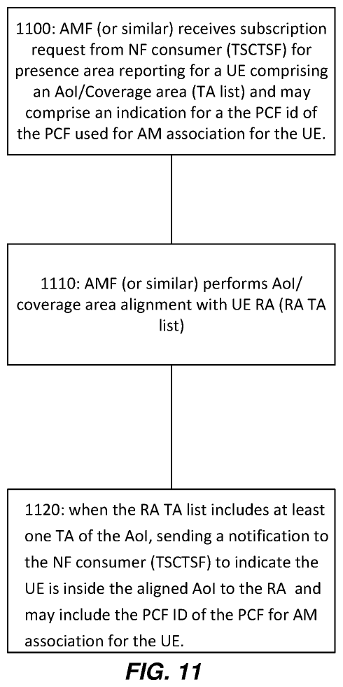

FIG. 11 is a flowchart describing the steps of TA alignments performed by an AMF serving a UE in accordance with for example FIGS. 6 and/or 7.

At step 1100, the AMF receives a subscription request for presence area reporting from a TSCTSF comprising a requested coverage area for determining UE presence and an event type “PRESENCE_IN_AOI_REPORT”. The coverage area includes a list of TAs determined by the TSCTSF based on a coverage area obtained from an AF requesting time synchronization service and in which time synchronization is to be activated by the TSCTSF. The subscription request may include an indication to further request the AMF to report the PCF Identifier handling the AM policy association for the UE and optionally to request reporting the binding information. In one example the indicator for the PCF Identifier is a Boolean value set to true to indicate that the AMF should report the PCF ID handling the AM Policy Association for the UE together with the relevant binding information. The indicator may also be set to false (default) (or indicator is absent) when AMF doesn't need to report a PCF ID handling AM Policy together with the relevant binding information. The AMF may also receive two Boolean values one for the PCF ID and another for the binding information. Note that even if the indicator is absent, the AMF may still include the PCF ID information and optionally the binding information in the notification to the TSCTSF at step 1120.

At step 1110, the AMF performs an alignment of the coverage area included as the area of interest in the subscription to presence area reporting with the Registration Area (RA) of the UE. The RA includes TAs that constitute a complete Registration Area (RA) of a UE, the UE being targeted by the AF request for time synchronization service activation. For example, the AMF performs the TA alignment with the RA as the following:
a) If the received area (coverage area or area for presence area reporting) in the subscription from TSCTSF contains some TA(s) outside the RA and some TAs within the RA, the AMF determines that the coverage area (i.e., the area for presence area reporting) shall be contained within the RA, i.e., the area for presence area reporting includes TAs in the RA which comprises some overlapped TAs from the TSCTSF and the synchronization service will be activated only in the TAs comprised in the RA or in the RA (excluding the TAs from the coverage area that are outside the RA). The AMF would report the UE is IN the area (restrained received area aligned with the RA).
b) If the received area (coverage area or area for presence area reporting) contains TA(s) that are all within the RA but the RA may include also other TA(s), the AMF determines that the coverage area (i.e., the area for presence area reporting) shall be expanded/aligned to the full RA (i.e., new TA(s) may be added to the list of TA specifying the received area if the RA is larger than the received area). The synchronization service will be activated in all the TAs of the RA (beyond the requested coverage area). The AMF report the UE is IN the area (expanded received area aligned with RA).

At step 1120, the AMF will then notify the TSCTSF of the PRESENCE_IN_AOI_REPORT event, indicating the presence of the UE(s) within the coverage area/AoI that has been aligned with the RA of the UE. i.e., if a) (above) or b) (above) the UE is reported as IN, if no alignment to RA can be done because there are no TAs in the received area that are in the RA, the AMF reports the UE as OUT of the area. The AMF may also include an indication in the presence area reporting to the TSCTSF that the coverage area has been restrained or expanded (to align with the RA) i.e., that the TA list provided in the subscription has been modified to align with the RA.

In another example, the AMF may also indicate to the TSCTSF that coverage area (i.e., updated TA list) is updated to align with the RA of the UE, or in another example, the AMF may alternatively or in addition include information indicative of the list of TAs used for presence area reporting. More specifically, it may only include the added or removed TAs from the coverage area (area of interest) due to the alignment with the RA, or it may simply include an updated TA list comprising all the TAs used as updated coverage area/area of interest) based on the received coverage/area of interest TA list and RA TA list. The updated TA list is then considered an area where time synchronization service can be activated.

In one example, the AMF includes in the same presence area report notification to the TSCTSF the PCF identifier (PCF ID) handling the AM Policy, and may also include the relevant binding information. If binding information is to be included, the AMF sends an additional information containing Binding indications of the PCF's AM policy association resources set to the value of the 3gpp-Sbi-Binding header defined without necessarily the header name.

In some embodiments, the AMF includes the PCF ID handling the AM policy association if the event report indicates the UE is IN the AoI and may omit the PCF ID if the UE is OUT of the AoI.

In some embodiments the subscription request is an Namf_EventExposure_subscribe HTTP message and the notification is an Namf_EventExposure_Notify as used in the 5G Service Based Interface (SBI) architecture.

FIG. 11b is a flowchart describing another method in TSCTSF when AMF performs TA alignment as in FIG. 11.

At step 1100b, the TSCTSF receives a time synchronization service request or a request to influence the 5G access stratum time distribution from for example an AF or NEF for at least one UE and comprising one or more TAs (coverage area) in which the service request is valid. The time synchronization service request is for example a request to activate time synchronization or a request to activate the 5G access stratum time distribution).

At step 1110b, the TSCTSF discovers the AMFs serving the one or more UEs in order to send a subscription request for event “PRESENCE_IN_AOI_REPORT” to each of the AMF(s) (at least one AMF) to request to be notified of UE presence in a requested coverage area/AoI which is based on the coverage area received in the service request. The requested coverage area/AoI includes a list of TAs determined by the TSCTSF based on a coverage area obtained from an AF requesting time synchronization service and in which time synchronization is to be activated by the TSCTSF. The subscription request to the AMF(s) may include an indication to further request an AMF to report the PCF Identifier handling the AM policy association for the UE and optionally to request reporting the binding information. In one example the indicator for the PCF Identifier is a Boolean value set to true to indicate that the AMF should report the PCF ID handling the AM Policy Association for the UE together with the relevant binding information. The indicator may also be set to false (default) (or indicator is absent) when AMF doesn't need to report a PCF ID handling AM Policy together with the relevant binding information. The TSCTSF may also provide two Boolean values; one for the PCF ID and another for the binding information. Note that even if the indicator is absent, the TSCTSF may still receive the PCF ID information and optionally the binding information in the notification from the AMF.

At step 1120b, the TSCTSF is notified by at least one of the AMFs of the PRESENCE_IN_AOI_REPORT event for one or more UE. The notification indicates the presence of the UE(s) (IN or OUT) within the coverage area/AoI that has been aligned with the RA of the UE at the AMF as explained above in FIG. 11. The AMF may also include an indication in the presence area reporting to the TSCTSF that the coverage area has been restrained or expanded (to align with the RA) i.e., that the TA list provided in the subscription has been modified to align with the RA.

In another example, the TSCTSF may also receive the coverage area (i.e., updated TA list) updated to align with the RA of the UE, or in another example, the TSCTSF may alternatively or in addition receive information indicative of the list of TAs used for presence area reporting. More specifically, the notification or report from the AMF may only include the added or removed TAs from the coverage area (area of interest) due to the alignment with the RA, or it may simply include an updated TA list comprising all the TAs used as updated coverage area/area of interest) based on the received coverage/area of interest TA list and RA TA list. The updated TA list is then for example considered an area where time synchronization service can be activated.

In one example, the TSCTSF receives in the same presence area report notification from an AMF the PCF identifier (PCF ID) handling the AM Policy association for the UE, and may also include the relevant binding information. If binding information is to be included, the TSCTSF receives an additional information containing Binding indications of the PCF's AM policy association resources set to the value of the 3gpp-Sbi-Binding header defined without necessarily the header name.

In some embodiments, the TSCTSF receives the PCF ID handling the AM policy association for the UE if the event report indicates the UE is IN the AoI and it may not be included if the UE is OUT of the AoI.

In some embodiments the subscription request is an Namf_EventExposure_subscribe HTTP message and the notification is an Namf_EventExposure_Notify as used in the 5G Service Based Interface (SBI) architecture.

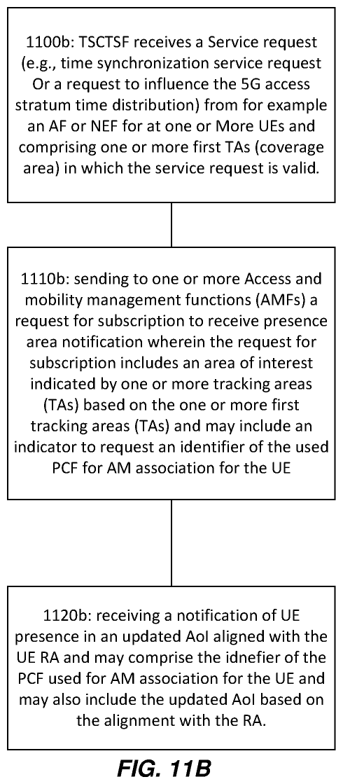

FIG. 12 is a schematic block diagram of a network node 1000 according to some embodiments of the present disclosure. Optional features are represented by dashed boxes. The network node 1000 may be, for example, a core network node that implements a NF (e.g., TSCTSF, NEF, AF, AMF, NF service consumer, or the like) or a network node that implements all or part of the functionality of an NF (e.g., all or part of the functionality of the AMF, TSCTSF, NEF, AF, NF service consumer, or the like, as described herein). As illustrated, the network node 1000 includes a one or more processors QQ204 (e.g., Central Processing Units (CPUs), Application Specific Integrated Circuits (ASICs), Field Programmable Gate Arrays (FPGAs), and/or the like), memory QQ206, and a network interface QQ208. The one or more processors QQ204 are also referred to herein as processing circuitry. The one or more processors QQ204 operate to provide one or more functions of the network node QQ200 as described herein (e.g., one or more functions of the PCF, TSCTSF, NEF, AF, NF service consumer, or the like, as described herein). In some embodiments, the function(s) are implemented in software that is stored, e.g., in the memory QQ206 and executed by the one or more processors QQ204.

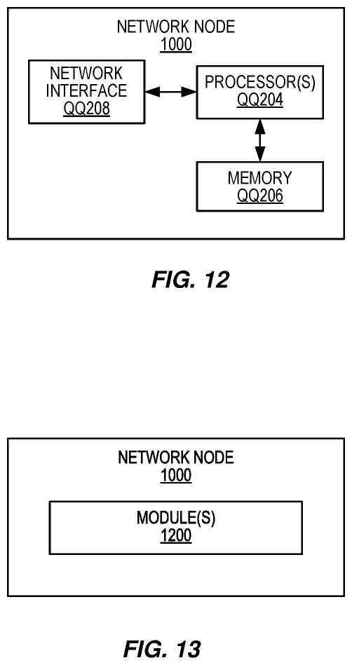

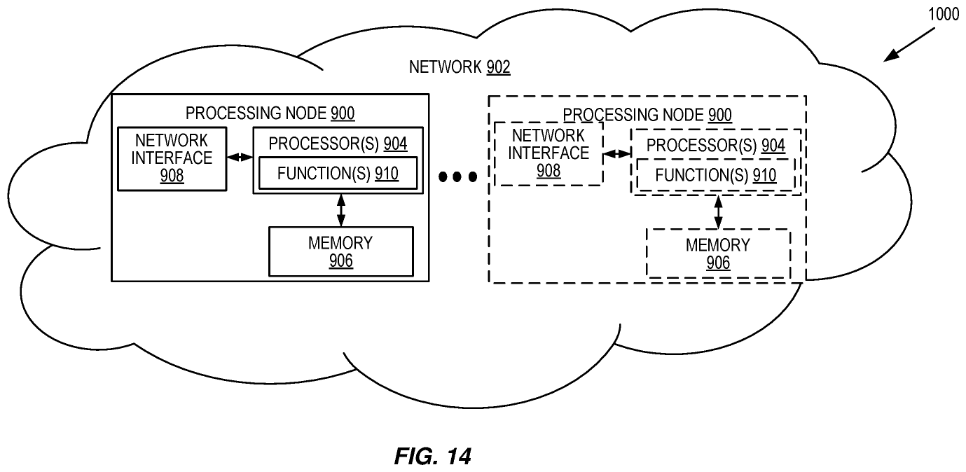

FIG. 13 is a schematic block diagram of the network node 1000 according to some other embodiments of the present disclosure. The network node 1000 includes one or more modules 1200, each of which is implemented in software. The module(s) 1200 provide the functionality of the network node 1000 described herein. This discussion is equally applicable to the processing node 900 of FIG. 14 below where the modules 1200 may be implemented at one of the processing nodes 900 of FIG. 14 (described below) or distributed across multiple processing nodes 900 of FIG. 14.

FIG. 14 is a schematic block diagram that illustrates a virtualized embodiment of the network node 1000 according to some embodiments of the present disclosure. Again, optional features are represented by dashed boxes. As used herein, a “virtualized” network node is an implementation of the network node 1000 in which at least a portion of the functionality of the network node 1000 is implemented as a virtual component(s) (e.g., via a virtual machine(s) executing on a physical processing node(s) in a network(s)). As illustrated, in this example, the network node 1000 includes one or more processing nodes 900 coupled to or included as part of a network(s) 902. Each processing node 900 includes one or more processors 904 (e.g., CPUs, ASICs, FPGAs, and/or the like), memory 906, and a network interface 908. In this example, functions 910 of the network node 1000 described herein (e.g., one or more functions of the AMF 200, TSCTSF 400, UDM, UDR, AF, PCF, or the like, as described herein) are implemented at the one or more processing nodes 900 or distributed across the two or more processing nodes 900 in any desired manner. In some particular embodiments, some or all of the functions 910 of the network node 1000 described herein are implemented as virtual components executed by one or more virtual machines implemented in a virtual environment(s) hosted by the processing node(s) 900.

In some embodiments, a computer program including instructions which, when executed by at least one processor, causes the at least one processor to carry out the functionality of the network node 1000 or a node (e.g., a processing node 900) implementing one or more of the functions 910 of the network node 1000 in a virtual environment according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processors (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

Those skilled in the art will recognize improvements and modifications to the embodiments of the present disclosure. All such improvements and modifications are considered within the scope of the concepts disclosed herein.

### Abbreviation:

| Abbreviation | Explanation |
|---|---|
| AoI | Area of Interest |
| ASTI | Access stratum time distribution |
| AMF | Access and Mobility Management Function |
| AF | Application Function |
| BSF | Binding Support Function |
| NEF | Network Exposure Function |
| NRF | NF Repository Function |
| NF | Network Function |
| PCF | Policy Control Function |
| RA | Registration Area |
| RAM | Random Access Memory |
| ROM | Read Only Memory |
| SBI | Service Based Interface |
| TAI | Tracking Area Identity |
| TA | Tracking Area |
| TSCTSF | Time Sensitive Communication and Time Synchronization |
| | Function |

1. A method performed by a network function, the method comprising:
receiving a service request for providing time synchronization a service in a coverage area for one or more User Equipments (UEs), the service request comprising a coverage area corresponding to one or more first tracking areas (TAs);
sending to an Access and mobility management function (AMF) a subscription request to receive notification about a UE presence in an area of interest (AoI) wherein the subscription request includes the area of interest (AoI) comprising one or more tracking areas (TAs) determined based on the one or more first tracking areas (TAs);
in response to sending the subscription request, receiving a notification from the AMF indicating the UE is IN the area of interest when at least one tracking area or all tracking areas of the AoI is comprised in a Registration Area of the UE; and
activating time synchronization service when the notification indicates the UE is IN the AoI.

2. (canceled)

3. The method of claim 1 wherein the subscription request further comprises an indication to the AMF to provide an identification of a policy control function (PCF) used for Access and Mobility (AM) policy association for the UE.

4. The method of claim 1 wherein the notification comprises an identification of the policy control function (PCF) used for Access and Mobility (AM) policy association for the UE.

5. The method of claim 4 wherein the notification further comprises binding indication of the PCF's Access Mobility policy association resources.

6. (canceled)

7. (canceled)

8. The method of claim 1 wherein the service request is received from an application function (AF) or a Network Exposure Function (NEF) associated with a time sensitive network.

9. The method of claim 1 wherein the method further comprises discovering the AMF serving at least one of the one or more UEs.

10. The method of claim 1 wherein the network function is a Time Sensitive Communication and Time Synchronization Function (TSCTSF) in 5^{th} Generation System (5GS).

11. The method of claim 1 further comprising notifying an Application function or a Network Exposure Function (NEF) of the service request that the coverage area has been aligned with the RA.

12. The method of any of claims 1 to 11 where in the service request is at least one of a request for time synchronization activation or a request to influence the 5G access stratum time distribution.

13. A method performed by an access and mobility management function, the method comprising:
receiving from a Time Sensitive Communication and Time Synchronization Function (TSCTSF) a subscription request for presence in area of interest reporting for a UE wherein the subscription request includes an area of interest (AoI) comprising one or more tracking areas (TAs);
in response to the subscription request, transmitting a notification to the TSCTSF indicating the UE is IN the area of interest when at least one tracking area or all tracking areas of the AoI is comprised in a Registration Area of the UE.

14. The method of claim 13 wherein the method further comprises transmitting a notification from the AMF indicating the UE is OUT of the area of interest when all tracking areas of the AoI are outside the Registration Area of the UE.

15. The method of claim 13 wherein the subscription request comprises an indication to provide an identification of a policy control function (PCF) used for Access and Mobility (AM) policy association for the UE.

16. The method of claim 13 wherein the notification comprises an identification of the policy control function (PCF) used for Access and Mobility (AM) policy association for the UE.

17. The method of claim 16 wherein the notification further comprises binding indication of the PCF's Access Mobility policy association resources.

18. (canceled)

19. (canceled)

20. (canceled)

21. A network node comprising one or more processors and memory comprising instructions which when executed by the one or more processors configures the network node to:
receive a service request for providing time synchronization a service in a coverage area for one or more User Equipments (UEs), the service request comprising a coverage area corresponding to one or more first tracking areas (TAs);
send to an Access and mobility management function (AMF) a subscription request to receive notification about a UE presence in an area of interest (AoI) wherein the subscription request includes the area of interest (AoI) comprising one or more tracking areas (TAs) determined based on the one or more first tracking areas (TAs);
in response to sending the subscription request, receive a notification from the AMF indicating the UE is IN the area of interest when at least one tracking area or all tracking areas of the AoI is comprised in a Registration Area of the UE; and
activate time synchronization service when the notification indicates the UE is IN the AoI.

22. The network node of claim 21 wherein the AoI comprising one or more tracking areas (TAs) determined based on the one or more first tracking areas (TAs) corresponding to the coverage area further comprises the AoI comprising one or more tracking areas (TAs) corresponding to a subset of the one or more first tracking areas (TAs).

23. The network node of claim 21 wherein the network node is further configured to receive a notification from the AMF indicating the UE is OUT of the area of interest when all tracking areas of the AoI are outside the Registration Area of the UE.

24. The method of claim 1 wherein the AoI comprising one or more tracking areas (TAs) determined based on the one or more first tracking areas (TAs) corresponding to the coverage area further comprises the AoI comprising one or more tracking areas (TAs) corresponding to a subset of the one or more first tracking areas (TAs).

25. The method of claim 1 wherein the method further comprises receiving a notification from the AMF indicating the UE is OUT of the area of interest when all tracking areas of the AoI are outside the Registration Area of the UE.
